(19) United States
(12) Patent Application Publication
(10) Pub. No.: US 2021/0041602 A1
(43) Pub. Date: Feb. 11, 2021

(54) Privacy Screen Protector

(71) Applicant: Panzer Glass A/S, Hinnerup (DK)

(72) Inventor: Mikkel Gudsøe, Egå (DK)

(21) Appl. No.: 16/964,241

(22) PCT Filed: Jan. 24, 2019
(86) PCT No.: PCT/DK2019/050029

§ 371 Date: Jul. 23, 2020

(30) Foreign Application Priority Data
Jan. 24, 2018 (DK) PA 2018 70050

(51) Int. Cl. G02B 1/14; G06F 1/16

(52) U.S. Cl. CPC G02B 1/14; G06F 1/1605; G06F 1/1626; G06F 1/1609

(57) ABSTRACT

Screen protector (1) for fitting on screens (20) for telephones and tablets, where the screen protector (1) comprises a construction of at least two layers, an adhesive layer (11) and a protective layer (12). The screen protector (1) comprises a through-hole (2) in a region where a camera and/or a sensor are mounted in the screen (20), such as in the edge region (4) of the screen, and a movable element (3) that is not transparent is mounted in the opening of the hole, so that in a closed position the movable element (3) blocks the camera and/or sensor, and in at least one non-closed position it allows the camera and/or sensor to be uncovered, said movable element (3) being configured for retention in the through-hole (2) with the screen protector (1) in the mounted state.

### FIELD OF THE INVENTION

The present invention relates to a privacy screen protector for fitting on screens for telephones and tablets and screens for other portable display equipment, where the screen protector comprises at least two layers, an adhesive layer and a protective layer, where the screen protector has an inner side, which will be facing towards the screen during use, and an outer side, which will be facing away from the screen during use.

### BACKGROUND OF THE INVENTION

Telephones and tablets are in common use in many contexts and situations. Since telephones and tablets are mobile and are taken along in many activities in for example pockets and bags, the screens are exposed to various external influences. Screen wear and screen breakage are therefore a common consequence. Screen protectors are used for protecting the screen of telephones and tablets against external influences, thereby extending the equipment life.

These screen protectors generally consist of at least two layers: an adhesive layer on an inner side of the screen protector, which is facing towards the screen of the device on which the screen protector is fitted, and a protective layer, which is on an outer side opposite the inner side of the screen protector.

Apps on both telephones and tablets that are authorized to use the camera and/or sensors can activate these, without the user being informed about this, and they can be activated against the user's will, for example as a result of hacking, viruses or similar. Therefore it may be an advantage if the user is able to limit the field of view of the camera and/or sensors, so that data cannot be picked up from the surroundings in case of undesirable activation. This can be done by fitting an element, which is not transparent, in front of the camera and/or sensors.

For this purpose, mechanical slides are available, which can be glued on the screen, or a screen protector. However, they have the drawback that they are unsightly and project well beyond the edge of the screen or the screen protector. Furthermore, they may become detached from the glued region during use.

### AIM OF THE INVENTION

The aim of the invention is to provide a screen protector, where the screen protector makes it possible to limit the field of view of a camera and/or sensors.

### DESCRIPTION OF THE INVENTION

This aim is achieved with a screen protector of the type mentioned in the introduction, which has the distinctive feature that the screen protector further comprises a through-hole in an edge region, where a camera and/or a sensor is mounted in the screen, thus in the edge region of the screen, and that a movable element, which is made of a non-transparent material, is fitted in the opening of the hole, so that in a closed position the movable element blocks the camera and/or sensor, and in at least one non-closed position allows the camera and/or sensor to be uncovered, said movable element being configured for retention in the through-hole with the screen protector in the mounted state.

Accordingly, the screen protector comprises a manual attachment, which may be operated so that the camera incorporated in the device may be blocked or unblocked so as to be exposed again. The screen protector itself may be completely transparent or have an extra filter layer, which gives the screen protector an additional privacy effect.

The screen protector may be adapted to the properties and/or design of a specific device. In other words, the shape may be adapted to the shape of the device, for instance there may be openings or holes in the screen protector for using operating elements in the device.

The area of the through-hole is as a rule small relative to the area that is covered by the whole screen protector.

The protective layer may be made of glass or other materials, such as a mixture of glass and plastic/polymer or carbon. For example, polyethylene terephthalate (PET), polycarbonate (PC), acrylonitrile butadiene styrene (ABS) and a mixture of PC and ABS are suitable. In such a construction the screen protector may comprise glass in the portion of the screen protector that covers the screen, and comprise plastic/polymer or carbon in the portion of the screen protector that covers the frame of the screen.

Another possible material is silicone resin.

The screen protector may also comprise several layers in addition to the protective and adhesive layer, for example an oleophobic layer against fingerprints.

The screen protector may be made flat or curved. This applies both to the central portion of the screen protector and to the peripheral portion of the screen protector. As a starting point the central portion may be only slightly curved, so that it can be adapted to a curved screen. The peripheral portion may be more curved, so that it can be adapted to the lateral edges of the telephone or tablet.

In a further embodiment the screen protector has the distinctive feature that the through-hole has a first part on the inner side of the screen protector, and a second part, which during use will be facing away from the screen in relation to the first portion of the through-hole, said first portion of the through-hole has a greater extension than the second portion of the through-hole, that the movable element comprises at least one first part and one second part, where the first part has a greater extension than the second part, when viewed perpendicularly to the screen protector, that the first part of the movable element is configured for fitting into the first portion of the through-hole, that the second part of the movable element is configured for fitting into the second portion of the through-hole, so that the movable element cannot come out of the hole when the screen protector is mounted on the screen.

The expression “perpendicular to” means, in the present application, a direction that is perpendicular to the inner side and outer side of the screen protector.

If the through-hole is positioned in a region where the screen protector is made of a hard material, such as glass, the movable element is preferably made of a flexible material, preferably plastic, such as silicone. This makes it easy to fit the movable element in the through-hole. Placement of the movable element may take place by temporary deformation of the flexible movable element.

If the through-hole is positioned in a region where the screen protector is made of a flexible material, such as plastic or carbon, the movable element may be made of a hard material, such as hard plastic, carbon or metal. Placement of the movable element may take place by temporary deformation of the material of the screen protector in the edge region around the hole.

The movable element may be made of a wide range of materials. For example, polyethylene terephthalate (PET), polycarbonate (PC), acrylonitrile butadiene styrene (ABS) and a mixture of PC and ABS are suitable.

According to a further embodiment the screen protector has the distinctive feature that the first portion of the through-hole is formed in the adhesive layer of the screen protector.

According to a further embodiment the screen protector has the distinctive feature that the movable element further comprises a third part, which during use is positioned at a greater distance from the screen than the second part, and that the third part has a greater extension than the second part, when viewed perpendicularly to the screen protector.

The first and third part will then extend beyond the extent of the hole on each side of the screen protector. This ensures retention of the movable element in a situation where the screen protector is not mounted on the screen.

According to a further embodiment the screen protector has the distinctive feature that the movable element is made of a flexible material, preferably plastic, such as silicone.

According to a further embodiment the screen protector has the distinctive feature that the protective layer of the screen protector comprises a first central portion made of glass and another peripheral portion made of plastic or carbon.

The central portion of the screen protector will generally have a larger area than the area of the peripheral portion.

According to a further embodiment the screen protector has the distinctive feature that in the transition region from the peripheral portion to the central portion an overlap of the material of the peripheral portion over the glass in the central portion is provided on the outer side of the screen protector, said overlap preferably comprising a gradually decreasing or rounded edge.

The overlapping edge region reduces the visible assembly between the central portion and the peripheral portion. A transition from plastic or carbon material to glass would normally be visible, if there were no overlapping edge region of plastic. It is preferable for the overlapping plastic to have a rounded edge, as this also reduces the visibility.

According to a further embodiment the screen protector has the distinctive feature that the movable element comprises a first partial element and a second partial element, which are joined together by disengageable coupling members.

The coupling members may be made as a countersunk hole in one of the partial elements and a corresponding mushroom-shaped projecting portion on the other partial element. Other embodiments of the coupling members are possible, such as a screw connection, or a hole with a number of barbs and equivalent parts.

Construction of the movable element from two partial elements makes it possible to assemble and hold the movable element in the through-hole of the screen protector, without the latter being mounted on the screen. This is particularly advantageous when the movable element comprises the third part.

According to a further embodiment the screen protector has the distinctive feature that the movable element has an oblong shape, when viewed perpendicularly to the screen protector.

According to a further embodiment the screen protector has the distinctive feature that the movable element comprises at least one rounded edge.

The movable element may have sharp and/or rounded edges. This includes among other things lateral edges, end edges and flat sides. This further comprises the shape of the movable element viewed perpendicularly to the screen protector.

According to a further embodiment the screen protector has the distinctive feature that the movable element has a circular shape, when viewed perpendicularly to the screen protector.

The movable element may be made in various geometric shapes.

According to a further embodiment the screen protector has the distinctive feature that the movable element may be moved translationally viewed perpendicularly to the screen protector, wherein in the direction of translation the through-hole has a greater extent than the movable element.

The direction of translation may be parallel to a lateral edge of the screen protector, said lateral edge delimiting the edge region where the through-hole is made. Alternatively the direction of translation may be perpendicular to said lateral edge. Alternatively the direction of translation may be slanting relative to said lateral edge.

According to a further embodiment the screen protector has the distinctive feature that the movable element has an oblong shape with at least one partially circular end edge, and that the through-hole is made with a partially circular corner adapted to the partially circular end edge, and a triangular shape, where the side opposite the partially circular corner is formed by a circular arc, which is configured so that the movable element may be rotated about an axis perpendicular to the screen protector, wherein the partially circular end edge rotates, resting against the partially circular corner.

### DESCRIPTION OF THE DRAWINGS

The invention will be described hereunder, referring to the drawings, where

FIG. 1 shows a schematic diagram of a screen protector according to the invention viewed from the outer side with the movable element in a non-closed position,

FIG. 2 shows a schematic diagram of a screen protector according to the invention viewed from the outer side with the movable element in a closed position,

FIG. 3 shows a schematic diagram of a screen protector according to the invention viewed from the inner side that faces towards the screen (not shown) during use,

FIG. 4 shows a screen protector viewed from a side perpendicular to the outer side 5,

FIG. 5 shows an embodiment of the movable element viewed in a direction perpendicular to the outer side,

FIG. 6 shows the movable element seen in the figure in a direction parallel to the outer side,

FIG. 7 shows a further embodiment of the movable element viewed in a direction perpendicular to the outer side,

FIG. 8 shows the movable element seen in the figure in a direction parallel to the outer side,

FIG. 9 shows a further embodiment of the movable element viewed in a direction perpendicular to the outer side,

FIG. 10 shows the movable element seen in the figure in a direction parallel to the outer side,

FIG. 11 shows the protective layer of an embodiment of the screen protector viewed perpendicular to the layer,

FIG. 12 shows the adhesive layer 11 of an embodiment of the screen protector viewed perpendicular to the layer,

FIG. 13 shows the screen protector with the protective layer and the adhesive layer from FIGS. 11 and 12 viewed perpendicular to the layers,

FIG. 14 shows a further embodiment of the screen protector viewed perpendicular to the outer side,

FIG. 15 shows the embodiment of the screen protector seen in FIG. 14 perpendicular to the outer side,

FIG. 16 shows the movable element seen in FIGS. 14 and 15 viewed perpendicular to the outer side,

FIG. 17 shows the movable element seen in FIGS. 14 and 15 viewed parallel to the outer side,

FIG. 18 shows the screen protector viewed perpendicular to the inner side,

FIG. 19 shows a detail of a cross-section through a screen protector mounted on the screen of a telephone or tablet,

FIG. 20 shows a detail of a cross-section through a screen protector mounted on the screen of a telephone or tablet,

FIG. 21 shows a cross-section through an embodiment of the movable element viewed from a side perpendicular to the flat side of the screen protector, and

FIG. 22 shows a cross-section through an embodiment of the movable element viewed from a side perpendicular to the flat side of the screen protector

FIGS. 23a-f show a screen protector with a movable element that is displaced translationally, perpendicularly to a lateral edge of the screen protector.

It should be pointed out that identical elements on the drawings have identical numbers. Therefore all details in the individual illustrations of the invention will not necessarily be mentioned in connection with all the drawings.

### DETAILED DESCRIPTION OF THE INVENTION

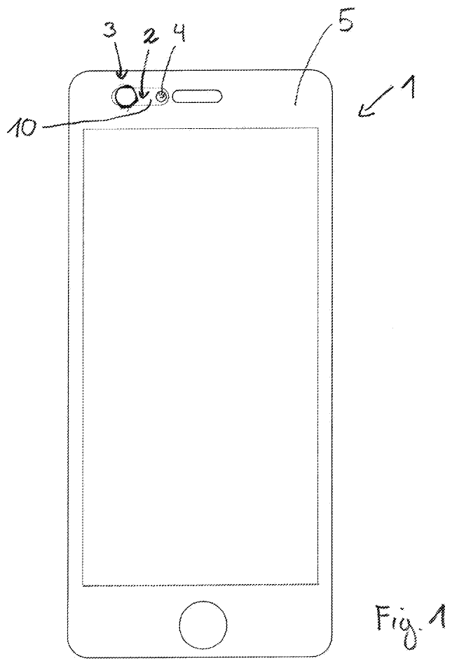

FIG. 1 shows a schematic diagram of a screen protector 1 according to the invention viewed from the outer side that faces away from the screen (not shown) during use. The through-hole 2 can be seen in region 4, where a camera and/or a sensor are mounted in the screen, and the movable element 3. The movable element 3 is in a non-closed position, where the camera or sensor is not blocked.

FIG. 2 shows a schematic diagram of a screen protector 1 according to the invention viewed from the outer side that faces away from the screen (not shown) during use.

The through-hole 2 can be seen in region 4, where a camera and/or a sensor are mounted in the screen, and the movable element 3. The movable element 3 is in a closed position, where the camera or sensor is blocked.

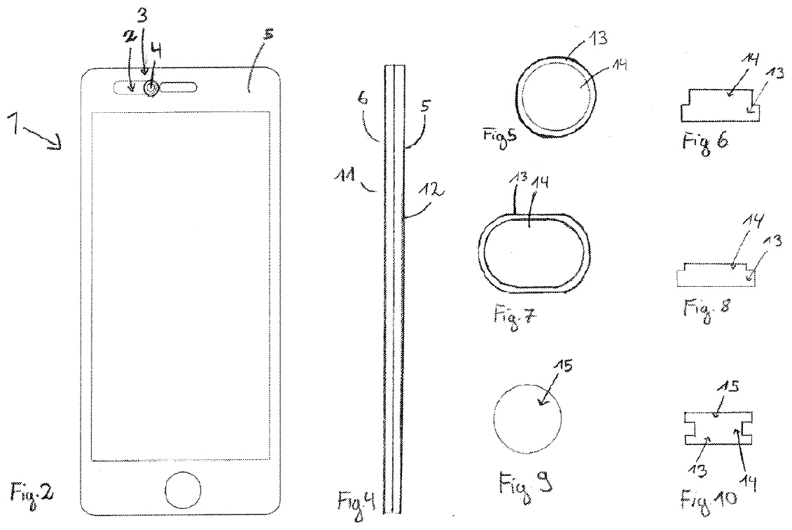

FIG. 3 shows a schematic diagram of a screen protector 1 according to the invention viewed from the inner side that faces towards the screen (not shown) during use. The through-hole 2 can be seen in region 4, where a camera and/or a sensor are mounted in the screen, and the movable element 3 in a non-closed position. The through-hole comprises a first portion 7 on the inner side 8 of the through-hole and a second portion 9 on the outer side 10.

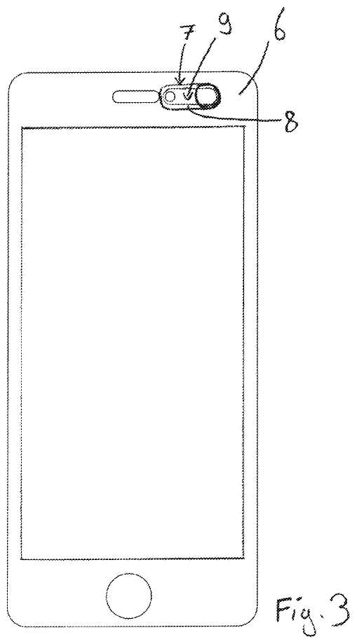

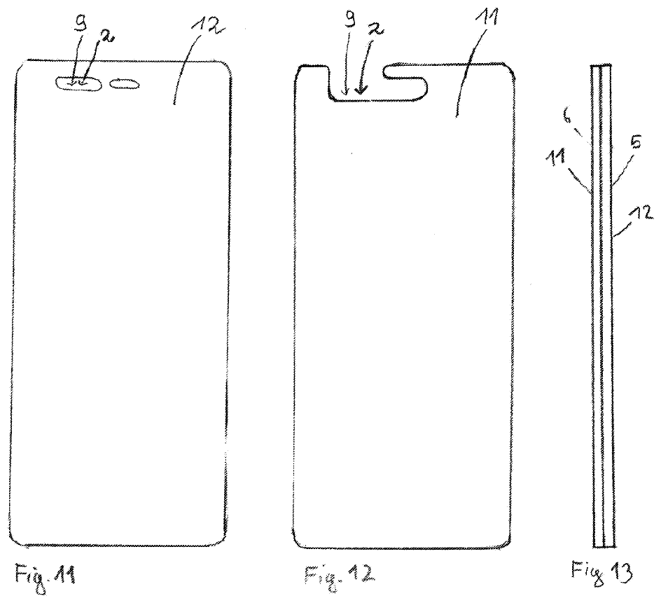

FIG. 4 shows a screen protector viewed from a side perpendicular to the outer side 5. A protective layer 12 facing towards the outer side 5, and an adhesive layer 11 facing towards the inner side can be seen.

FIG. 5 shows an embodiment of the movable element 3 viewed in a direction perpendicular to the outer side. The movable element 3 has a circular shape and comprises a first part 13 facing towards the inner side 6, and a second part 14 facing towards the outer side.

FIG. 6 shows the movable element 3 seen in FIG. 5 in a direction parallel to the outer side. The movable element 3 has a circular shape and comprises a first part 13 facing towards the inner side 6, and a second part 14 facing towards the outer side 5.

FIG. 7 shows a further embodiment of the movable element 3 viewed in a direction perpendicular to the outer side. The movable element 3 has an oblong shape with rounded edges and comprises a first part 13 facing towards the inner side 6, and a second part 14 facing towards the outer side 5.

FIG. 8 shows the movable element 3 seen in FIG. 7 in a direction parallel to the outer side. The movable element 3 comprises a first part 13 facing towards the inner side 6, and a second part 14 facing towards the outer side 5.

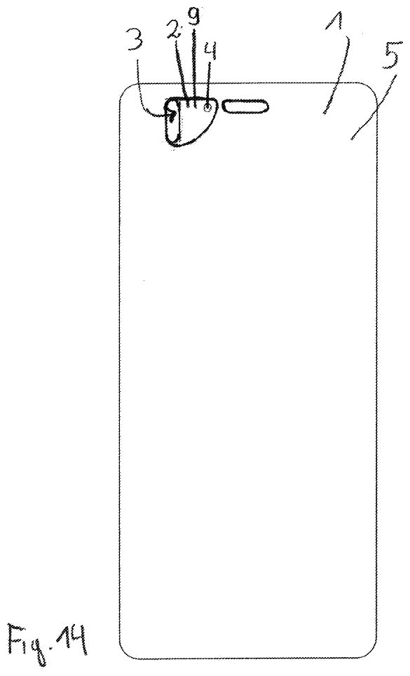

FIG. 9 shows a further embodiment of the movable element 3 viewed in a direction perpendicular to the outer side 5. The movable element 3 is of circular shape and comprises a first part 13 facing towards the inner side 6, a second part 14 and a third part 15 facing towards the outer side 5.

FIG. 10 shows the movable element 3 seen in FIG. 9 in a direction parallel to the outer side 5. The third part 15 of the movable element 3 facing towards the outer side 5 can be seen.

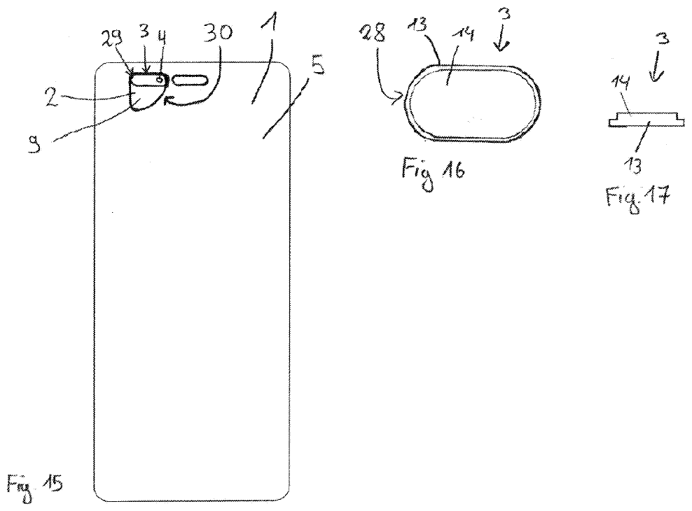

FIG. 11 shows the protective layer 12 of an embodiment of the screen protector viewed perpendicular to the layer. The second portion 19 of the through-hole 2 can be seen.

FIG. 12 shows the adhesive layer 11 of an embodiment of the screen protector viewed perpendicular to the layer. The first portion 18 of the through-hole 2 can be seen.

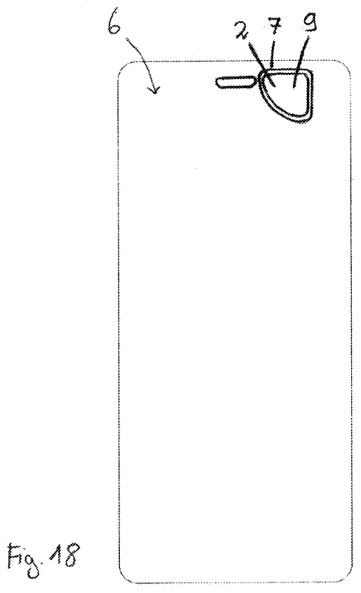

FIG. 13 shows the screen protector with the protective layer 12 and the adhesive layer 11 from FIGS. 11 and 12 viewed perpendicular to the layers.

FIG. 14 shows a further embodiment of the screen protector 1 viewed perpendicular to the outer side 5. The movable element 3 in one embodiment, which rotates in a non-closed position, can be seen.

FIG. 15 shows the embodiment of the screen protector 1 seen in FIG. 14 perpendicular to the outer side 5. The movable element 3 can be seen in a closed position.

FIG. 16 shows the movable element 3 seen in FIGS. 14 and 15 viewed perpendicular to the outer side 5. The movable element 3 comprises a first part 13 and a second part 14.

FIG. 17 shows the movable element seen in FIGS. 14 and 15 viewed parallel to the outer side 5. The movable element 3 comprises a first part 13 and a second part 14.

In FIGS. 15 to 17, it can be seen that the movable element 3 has an oblong shape with at least one partially circular end edge 28, and that the through-hole is made with a partially circular corner 29 adapted to the partially circular end edge 28 and a triangular shape, where the side opposite the partially circular corner 29 is formed by a circular arc 30, which is configured so that the movable element 3 may be rotated about an axis perpendicular to the screen protector, as the partially circular end edge 28 rotates while resting against the partially circular corner 29.

FIG. 18 shows the screen protector 1 viewed perpendicular to the inner side 6. The first portion 7 and the second portion 9 of the through-hole 2 can be seen.

FIG. 19 shows a detail of a cross-section through a screen protector 1 mounted on the screen 20 of a telephone or tablet 33. The screen protector comprises an adhesive layer 11 and a protective layer 12. The protective layer 11 consists of a central portion 23 made of glass and a peripheral portion 24 made of a plastic or carbon material, such as PET.

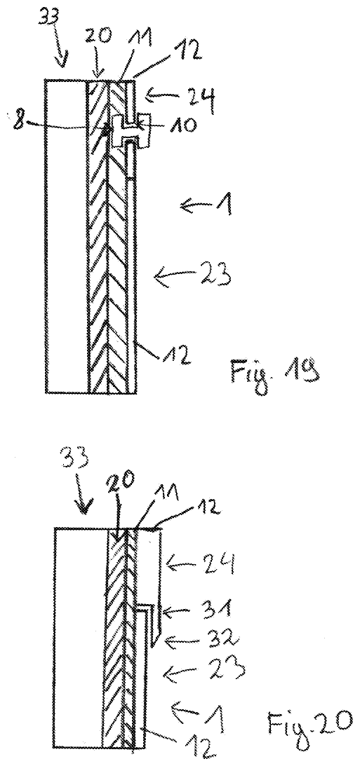

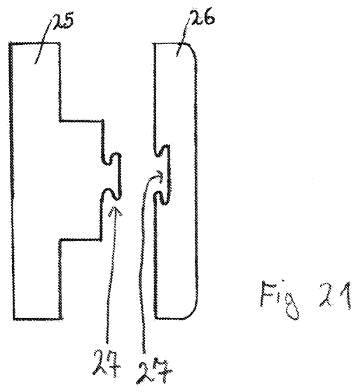

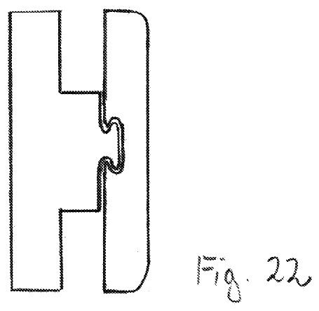

FIG. 20 shows a detail of a cross-section through a screen protector 1 mounted on the screen 20 of a telephone or tablet 33. The screen protector comprises an adhesive layer 11 and a protective layer 12. The protective layer 11 consists of a central portion 23 made of glass and a peripheral portion 24 made of a plastic or carbon material, such as PET. An overlap 31 of the material of the peripheral portion 24 over the glass is provided in the central portion 23 on the outer side 5 of the screen protector 1. The overlap 31 comprises a rounded edge 32. The rounded edge reduces the visible transition from the plastic material to the glass.

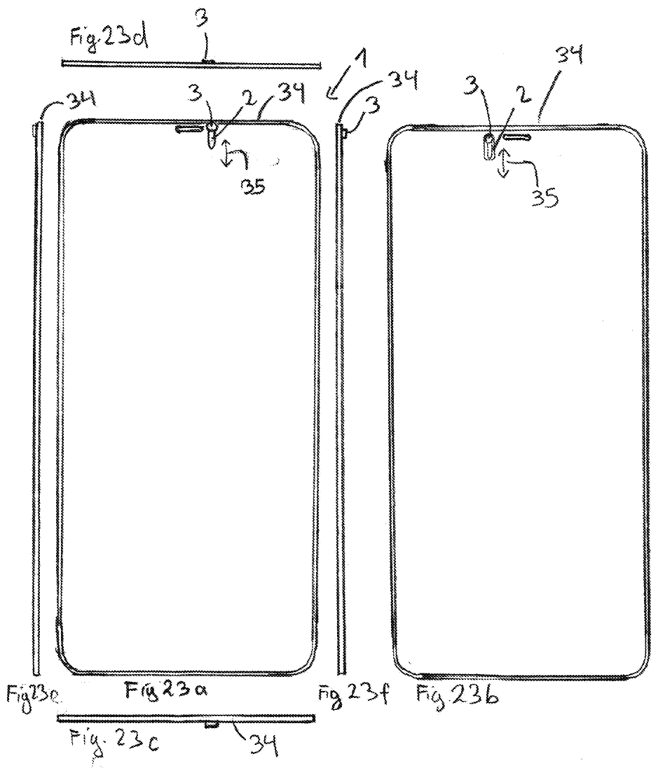

FIG. 21 shows a cross-section through an embodiment of the movable element 3 viewed from a side perpendicular to the flat side of the screen protector. The movable element 3 comprises a first partial element 25 and a second partial element 26, which are equipped with disengageable coupling members 27 in the form of a countersunk hole. The partial elements are shown in the non-assembled state.

FIG. 22 shows a cross-section through an embodiment of the movable element 3 viewed from a side perpendicular to the flat side of the screen protector. The movable element 3 comprises a first partial element 25 and a second partial element 26, which are equipped with disengageable coupling members 27 in the form of a countersunk hole. The partial elements are shown in the non-assembled state.

FIGS. 23a-f show an embodiment of a screen protector 1 with a through-hole 2 and a movable element 3.

FIG. 23a shows the screen protector viewed from the outer side. FIG. 23b shows the screen protector viewed from the inner side. FIG. 23c shows the screen protector from above. FIG. 23d shows the screen protector viewed from below. FIG. 23e shows the screen protector from one side and FIG. 23f shows the screen protector from the other side.

The movable element may be moved translationally in the direction 35 perpendicular to the lateral edge 34 of the screen protector. The through-hole 2 has a greater extent than the movable element 3 in the direction 35 of translation. Translation is performed perpendicular to the lateral edge 34.

This is an alternative to the embodiment shown in FIG. 1. Here the translation is performed in a direction parallel to the lateral edge 34.

Alternatively the translational movement may be performed in another direction, such as slanting relative to the lateral edge 34.

### REFERENCE SYMBOLS

1. Screen protector
2. Through-hole
3. Movable element
4. Region where a camera and/or a sensor are mounted in the screen
5. Outer side of the screen protector
6. Inner side of the screen protector
7. First portion of the through-hole
8. Inner side of the through-hole
9. Second portion of the through-hole
10. Outer side of the through-hole
11. Adhesive layer
12. Protective layer
13. First part of the movable element
14. Second part of the movable element
15. Third part of the movable element
20. Screen
23. Central portion
24. Peripheral portion
25. First partial element of the movable element
26. Second partial element of the movable element
27. Disengageable coupling members
28. Partially circular end edge
29. Partially circular corner
30. Circular arc
31. Overlap
32. Rounded edge
33. Telephone or tablet
34. Lateral edge
35. Direction of translation

1. Screen protector (1) for fitting on screens (20) for telephones and tablets and screens for other portable display devices, where the screen protector (1) comprises at least two layers, an adhesive layer (11) and a protective layer (12), where the screen protector (1) has an inner side (6), which will be facing towards the screen (20) during use, and an outer side (5), which will be facing away from the screen (20) during use, wherein the screen protector (1) further comprises a through-hole (2) in an edge region (4), where a camera and/or a sensor are mounted in the screen (20), such as in the edge region of the screen (21), and in that a movable element (3), which is made of a non-transparent material, is mounted in the opening of the hole (2), so that in a closed position the movable element (3) blocks the camera and/or sensor, and in at least one non-closed position allows the camera and/or sensor to be uncovered, said movable element (3) being configured for retention in the through-hole (2) in the fitted state of the screen protector (1).

2. Screen protector (1) according to claim 1, wherein the through-hole (2) has a first portion (7) on the inner side of the screen protector (6) and a second portion (9), which during use will be facing away from the screen (20) relative to the first portion (7) of the through-hole (2), said first portion (7) of the through-hole (2) having a greater extension than the second portion (9) of the through-hole (2), in that the movable element (3) comprises at least one first part (13) and second part (14), where the first part (13) has a greater extension than the second part (14), when viewed perpendicularly to the screen protector (1), in that the first part (13) of the movable element (3) is configured for fitting into the first portion (7) of the through-hole (2), in that the second part (14) of the movable element (3) is configured for fitting into the second portion (8) of the through-hole (2), so that the movable element (3) cannot come out of the hole (2) when the screen protector (1) is mounted on the screen (1).

3. Screen protector (1) according to claim 2, wherein the first portion (7) of the through-hole (2) is formed in the adhesive layer (11) of the screen protector (1).

4. Screen protector (1) according to claim 2, wherein the movable element (3) further comprises a third part (15), which during use is positioned at a greater distance from the screen (20) than the second part (14), and in that the third part (15) has a greater extension than the second part (14), when viewed perpendicularly to the screen protector (1).

5. Screen protector (1) according to claim 1, wherein the movable element (3) is made of a flexible material, preferably plastic, such as silicone.

6. Screen protector (1) according to claim 1, wherein the protective layer (12) of the screen protector (1) comprises a first central portion (23) made of glass and a peripheral portion (24) made of plastic or carbon.

7. Screen protector according to claim 6, wherein, in the transition region from the peripheral portion (24) to the central portion (23), an overlap (31) of the material of the peripheral portion (24) over the glass is provided in the central portion (23) on the outer side (5) of the screen protector (1), said overlap (31) preferably comprising a gradually decreasing or rounded edge (32).

8. Screen protector (1) according to claim 1, wherein the movable element (3) comprises a first partial element (25) and a second partial element (26), which are joined together by disengageable coupling members (27).

9. Screen protector (1) according to claim 1, wherein the movable element (3) has an oblong shape, when viewed perpendicularly to the screen protector (1).

10. Screen protector according to claim 1, wherein the movable element (3) has a circular shape, when viewed perpendicularly to the screen protector (1).

11. Screen protector (1) according to claim 1, wherein the movable element (3) can be moved translationally, viewed perpendicularly to the screen protector (1), so that in the direction of translation the through-hole (2) has a greater extent than the movable element (3).

12. Screen protector (1) according to claim 1, wherein the movable element (3) has an oblong shape with at least one partially circular end edge (28), and in that the through-hole (2) is made with a partially circular corner (29) adapted to the partially circular end edge (28), and a triangular shape, where the side opposite the partially circular corner is formed by a circular arc (30), which is configured so that the movable element (3) may be rotated about an axis perpendicular to the screen protector (1), so that the partially circular end edge (28) rotates resting against the partially circular corner (29).
